(19) United States
(12) Patent Application Publication
(10) Pub. No.: US 2011/0050542 A1
(43) Pub. Date: Mar. 3, 2011

(54) COMPUTER SYSTEM AND METHOD OF CONTROLLING THE SAME

(75) Inventor: Kyoung-won LEE, Gyeonggi-do (KR)

(73) Assignee: SAMSUNG ELECTRONICS CO., LTD., Gyeonggi-Do (KR)

(21) Appl. No.: 12/824,286

(22) Filed: Jun. 28, 2010

(30) Foreign Application Priority Data
Aug. 25, 2009 (KR) 10-2009-0078814

(51) Int. Cl. G09G 5/12

(52) U.S. Cl. 345/1.1

(57) ABSTRACT

A computer system which displays screens on a display unit for observing proper positioning and on an auxiliary display device and a method of controlling the same. A computer system including: a display unit; a plurality of ports connectable with at least one auxiliary display device; and a controller displaying a main screen on the display unit and an auxiliary screen corresponding to a position of a port coupled to the auxiliary display device from among the ports in the auxiliary display device. The computer system permits improved convenience when arranging displaying screens on a mounted display unit and in an auxiliary display device.

### CLAIM OF PRIORITY

This application claims the benefit of priority from Korean Patent Application No. 10-2009-0078814, filed on Aug. 25, 2009 in the Korean Intellectual Property Office, the disclosure of which is incorporated herein by reference in its entirety.

### BACKGROUND OF THE INVENTION

1. Field of the Invention

The present invention relates to a computer system and a method of controlling the same. More particularly, the present invention relates to a computer system which displays screens on a display unit and on an auxiliary display device and a method of controlling the same.

2. Description of the Related Art

A computer system, such as a laptop, notebook, netbook, tablet (pad), etc., may display a screen not only on a single display unit thereof, but also in other display devices (hereinafter, referred to as “auxiliary display devices”) in order to provide an improved display function.

According to such technology, which is often referred to as “multi-monitor,” “multi-display,” “dual monitor,” etc., a display unit of a computer system displays a main screen, and an auxiliary display device displays an auxiliary screen. Arrangement of the main screen and the auxiliary screen corresponds to the actual physical arrangement of the display unit and the auxiliary display device through display arrangement setting provided by an operating system or the like.

However, according to the conventional technology, a user is able to identify that the main screen and the auxiliary screen are properly arranged only after connecting the auxiliary display device to the computer system and then visually observing screens displayed on the display unit and the auxiliary display device. If the screens are not properly arranged, the user is inconvenienced and must then try a reconnection or a changing of settings.

Meanwhile, a computer system such as a desktop may also be coupled to a plurality of display devices, one of which functions as a main display device, and at least another of which serves as an auxiliary display device. In this case, a user also needs to check arrangement settings individually.

### SUMMARY OF THE INVENTION

Accordingly, one or more exemplary embodiments of the present invention provide a computer system with increase user convenience when displaying screens on a mounted display unit and in an auxiliary display device, and a method of controlling the same.

Another exemplary embodiment of the present invention provides a computer system with improved user convenience when displaying screens in a plurality of display devices, and a method of controlling the same.

The foregoing and/or other exemplary aspects of the present invention may be achieved by providing a computer system including: a display unit; a plurality of ports connectable with at least one auxiliary display device; and a controller displaying a main screen on the display unit and an auxiliary screen corresponding to a position of a port coupled to the auxiliary display device from among the ports in the auxiliary display device.

Each respective port of the plurality of ports may be arranged in a direction with respect to a standard position corresponding to the display unit, and the controller may display an auxiliary screen corresponding to the arrangement direction of the port with respect to the standard position in the auxiliary display device coupled to the port.

According to an exemplary aspect of the present invention, two or more of the ports may be arranged in the same direction with respect to the standard position, and the controller may display two or more auxiliary screens corresponding to relative positions of the two or more ports in the two or more auxiliary display devices coupled to the two or more ports.

The computer system may include, for example a housing in which the controller is provided, and each of the ports may be provided on a surface of the housing.

The controller may perform a display setting of the main screen and the auxiliary screen if the ports are coupled to the auxiliary display devices.

The controller may change the display settings of the main screen and the auxiliary screen according to an input from a user.

Another exemplary aspect of the present invention is achieved by providing a method of controlling a computer system including: determining a position of a particular port coupled to at least one auxiliary display device from among a plurality of ports of the computer system; and displaying a main screen on a display unit of the computer system and an auxiliary screen corresponding to the position of the particular port in the auxiliary display device.

Each of the ports may be arranged in a direction with respect to a standard position corresponding to the display unit, and the displaying the auxiliary screen may include displaying an auxiliary screen corresponding to the arrangement direction of the port with respect to the standard position in the auxiliary display device coupled to the port.

According to yet another exemplary aspect of the present invention, two or more of the ports may be arranged in the same direction with respect to the standard position, and the displaying the auxiliary screen may include displaying two or more auxiliary screens corresponding to relative positions of the two or more ports in the two or more auxiliary display devices coupled to the two or more ports.

The method may include, for example, performing display setting of the main screen and the auxiliary screen if the ports are coupled to the auxiliary display devices.

The method may include, for example, changing display settings of the main screen and the auxiliary screen according to input from a user.

Still another exemplary aspect of the present invention is achieved by providing a computer system including: a plurality of ports connectable with a plurality of display devices; and a controller displaying a main screen corresponding to relative positions of the ports coupled to the display devices and at least one auxiliary screen in the display devices coupled to the ports, respectively.

Yet another aspect of the present invention is achieved by providing a method of controlling a computer system including: determining relative positions of a plurality of ports of the computer system coupled to a plurality of display devices; and displaying a main screen corresponding to the relative positions of the ports and at least one auxiliary screen in the display devices coupled to the ports, respectively.

### BRIEF DESCRIPTION OF THE DRAWINGS

The above and/or other exemplary aspects will become apparent and more readily appreciated to a person of ordinary skill in the art from the following description of the exemplary embodiments, taken in conjunction with the accompanying drawings, in which:

FIG. 1 illustrates a computer system according to a first exemplary embodiment of the present invention;

FIG. 2 is a block diagram illustrating a configuration of the computer system according to the exemplary first embodiment of the present invention;

FIG. 3 is a flow chart illustrating an exemplary operation of the computer system according to the exemplary embodiment of the present invention;

FIG. 4 illustrates position determination of a port performed by the computer system according to the exemplary embodiment of the present invention;

FIG. 5 illustrates a main screen and an auxiliary screen displayed by the computer system according to the exemplary embodiment of the present invention;

FIG. 6 illustrates a main screen and an auxiliary screen displayed by a computer system according to a exemplary embodiment of the present invention;

FIG. 7 illustrates position determination of a port performed by the computer system according to a second exemplary embodiment of the present invention;

FIG. 8 illustrates a main screen and an auxiliary screen displayed by the computer system according to the second exemplary embodiment of the present invention;

FIG. 9 is a flow chart illustrating an exemplary operation of a computer system according to the first exemplary embodiment of the present invention;

FIG. 10 illustrates a computer system according to a second exemplary embodiment of the present invention; and

FIG. 11 is a flow chart illustrating an exemplary operation of the computer system according to the second exemplary embodiment of the present invention.

### DETAILED DESCRIPTION

Below, exemplary embodiments will be described in detail with reference to accompanying drawings so as to be realized by a person of ordinary skill in the art. The exemplary embodiments, which are provided for purposes of illustration and explanation, may be embodied in various forms not shown and do not limit the scope of the appended claims.

Descriptions of well-known structures and functions may be omitted for clarity when their inclusion might obscure appreciation of the subject matter of the present invention by a person of ordinary skill in the art, and like reference numerals generally refer to like elements throughout the disclosure.

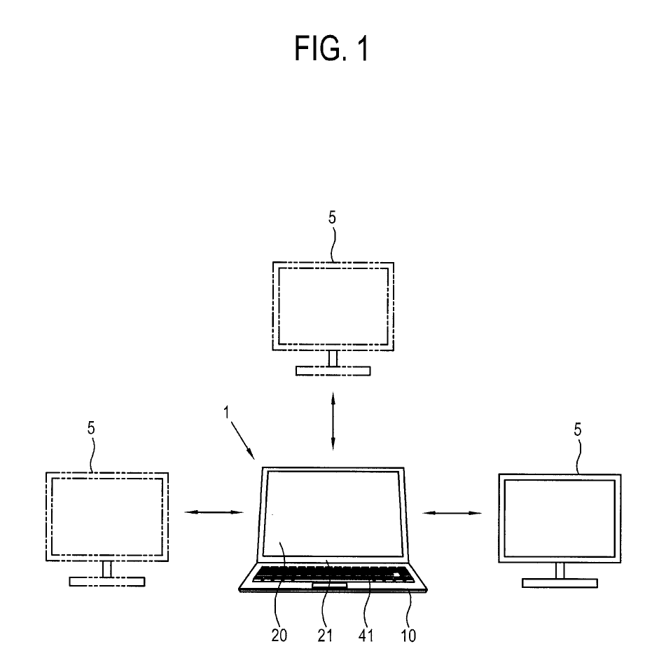

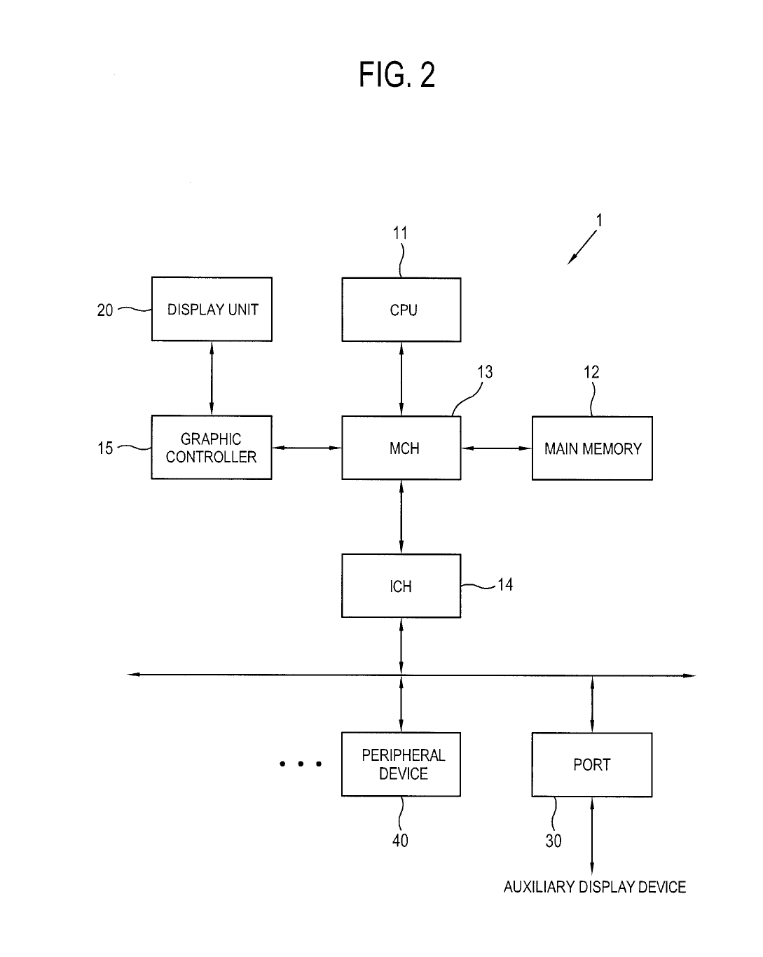

FIG. 1 illustrates a computer system according to a first exemplary embodiment of the present invention. The computer system 1 shown in FIG. 1 may be realized as a personal computer (PC), such as a laptop, notebook, netbook, tablet pad, etc. The computer system 1 according to the present exemplary embodiment may be coupled to at least one display device 5 (hereinafter, referred to as “auxiliary display device”). The computer system 1 displays a screen not only on a display unit 20 (see FIG. 2) thereof but also on the coupled auxiliary display device 5.

As shown in FIG. 1, the auxiliary display device 5 may be disposed in many different positions to the computer system 1 according to environments for users. For example, the auxiliary display device 5 may be disposed next to the computer system 1 or behind the computer system 1. However, such positions of the auxiliary display device 5 are only illustrative examples, but the auxiliary display device 5 may be disposed in different locations depending on particular environments.

FIG. 2 is a block diagram illustrating a configuration of the computer system 1 shown in FIG. 1. The computer system 1, as shown in FIG. 2, preferably includes a central processing unit (CPU) 11, a main memory 12, a memory controller hub (MCH) 13, an input/output (I/O) controller hub (ICH) 14, a graphic controller 15, display unit 20, and a peripheral device 40.

The CPU 11 is a component controlling an overall operation of the computer system 1 and executes a computer program loaded in the main memory 12. In executing a computer program, the CPU 11 communicates with the MCH 13, the ICH 14, and the peripheral device 40 and controls each of them.

The main memory 12 temporarily stores data while performing operations of the CPU 11 including a computer program performed by the CPU 11. The main memory 12 is a volatile memory and may be realized as a double data rate synchronous dynamic random access memory (DDR SDRAM), just as one possible example.

The graphic controller 15 processes a graphic data, and the display unit 20 displays an image on the basis of a graphic data processed by the graphic controller 15. The display unit 20 may be provided as a liquid crystal display (LCD), or any other type of thin film technology.

The peripheral device 40 may include various hardware, e.g., a keyboard, a mouse, a tablet, a touch screen, a hard disk drive, a flash memory, a CD-ROM, a DVD-ROM, a USB drive, a modem, a network card, a Bluetooth adaptor, a sound card, a speaker, a microphone, etc., just to name a few of the many possibilities.

The MCH 13 interfaces a component, such as the CPU 11 or the like, with the main memory 12 in order to read and write a data. The ICH 14 interfaces the CPU 11 with the peripheral device 40 to communicate.

A combination of the CPU 11, the main memory 12, the MCH 13, the ICH 14, and the graphic controller 15 in the present exemplary embodiment is an illustrative example of a controller. Hereinafter, a reference numeral of the controller will be omitted in consideration of convenience in the description according to the exemplary embodiment. The controller of the present exemplary embodiment may further include a basic input/output system (BIOS) firmware interface, an operating system (including various device drivers) and an application in addition to the foregoing components. In the present embodiment, the BIOS may be stored in a BIOS ROM, which is a nonvolatile memory, and the operating system and the application may be installed, for example, in a hard disk drive.

The computer system 1 according to the present exemplary embodiment further includes a plurality of ports 30. The ports 30 are coupled to at least one auxiliary display device 5, and the controller of the present embodiment transmits an image signal to the auxiliary display device 5 through a respective one of the ports 30. The ports 30 preferably include a USB port. In this case, the controller of the present exemplary embodiment may further include a USB controller (not shown) performing data communication according to a USB protocol.

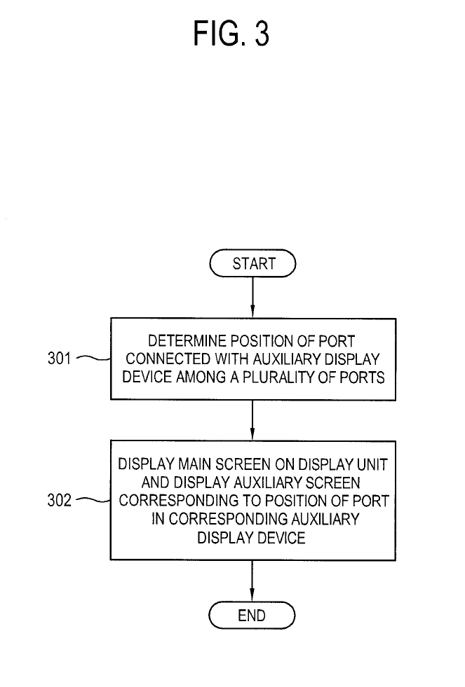

The computer system 1 according to the exemplary embodiment will be explained in more detail with reference to FIG. 3. FIG. 3 is a flow chart illustrating an exemplary operation of the computer system 1 according to the exemplary embodiment. As shown in FIG. 3, at step (301), the controller of the computer system 1 determines a position of a port from among the ports 30 which is coupled to the auxiliary display device.

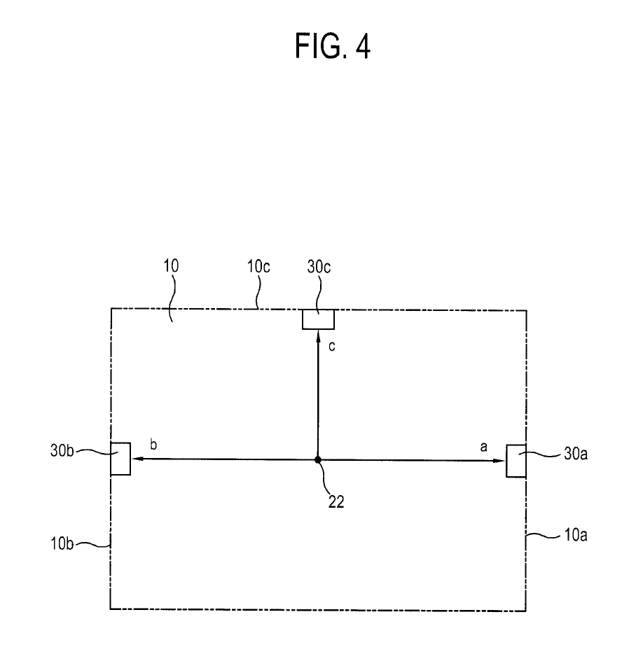

FIG. 4 is a reference view explaining how a position of the ports 30 of the computer system 1 is determined according to the exemplary embodiment. The computer system 1 of the present embodiment includes the controller therein and may further include a housing 10 to protect the controller from the outside environment. Another component of the computer system 1, e.g., the peripheral device 40 such as a keyboard 41 (FIG. 1), may be further provided in the housing 10 in addition to the controller.

The display unit 20 of the present exemplary embodiment may be opened or closed to the housing 10. FIG. 1 shows the display unit 20 being opened relative to the housing 10. The computer system 1 may further include a display housing 21 (FIG. 1) protecting the display unit 20 from the outside and a hinge (not shown) provided between the housing 10 and the display housing 21 and allowing the display unit 20 to be opened or closed.

Referring back to FIG. 4, the plurality of ports 30 of the present exemplary embodiment may be disposed in different directions (a, b, and c), respectively, on a standard position 22 corresponding to the display unit 20. The plurality of ports 30 of the present exemplary embodiment may include, for example, three ports 30a, 30b, and 30c, as shown in FIG. 4. The three ports 30a, 30b, and 30c are disposed in a first direction (a), in a second direction (b), and in a third direction (c), respectively, on the standard position 22 corresponding to the display unit 20. In other words, each of the ports (30a, 30b, 30c) are arranged in a direction with respect to a standard position (22) corresponding to an orientation of the display unit (20), and the controller displays an auxiliary screen (51) corresponding to the arrangement direction of the particular port with respect to the standard position in the auxiliary display device (5) coupled to the particular port.

Meanwhile, FIG. 4 shows the positions of the ports 30 when a user views the housing 10 from the top (plan view). In this case, the three ports 30a, 30b, and 30c of the present embodiment may be disposed on both lateral sides 10a and 10b of the housing 10 and a rear side 10c of the housing 10, respectively. In the present exemplary embodiment, the first direction (a), the second direction (b), and the third direction (c) correspond to the lateral sides 10a and 10b, or the housing 10 and the rear side 10c of the housing 10, respectively.

Information about the positions of the ports 30 in the present exemplary embodiment may be stored in advance in a storage unit such as a hard disk drive. The controller of the present embodiment determines a position of a port among the ports 30 which is coupled to the auxiliary display device 5 on the basis of the information about the positions of the ports 30 previously stored.

The arrangement of the ports 30 shown in FIG. 4 is only an illustrative example, and the plurality of ports according to the present exemplary embodiment may be disposed in various positions and in various quantities. For example, a port may not be disposed either on the lateral sides 30a and 30b of the housing 10 or on the rear side 30c of the housing 10. Instead, at least one of the ports according to the present exemplary embodiment may be disposed in front of the housing 10 or in any position of the display housing 21.

Referring back to FIG. 3, at step (302) the controller of the present embodiment displays a main screen on the display unit 20 and an auxiliary screen corresponding to a position of a port 30 on the auxiliary display device 5 coupled to the corresponding port 30.

A main screen of the present exemplary embodiment comprises a general screen, which is the same as in the case where the auxiliary display device 5 is not connected. An auxiliary screen of the present exemplary embodiment is provided by a display function, so called “multi-monitor” or “multi-display” and may be displayed in a clone mode, in an enlargement mode, and in an expansion mode.

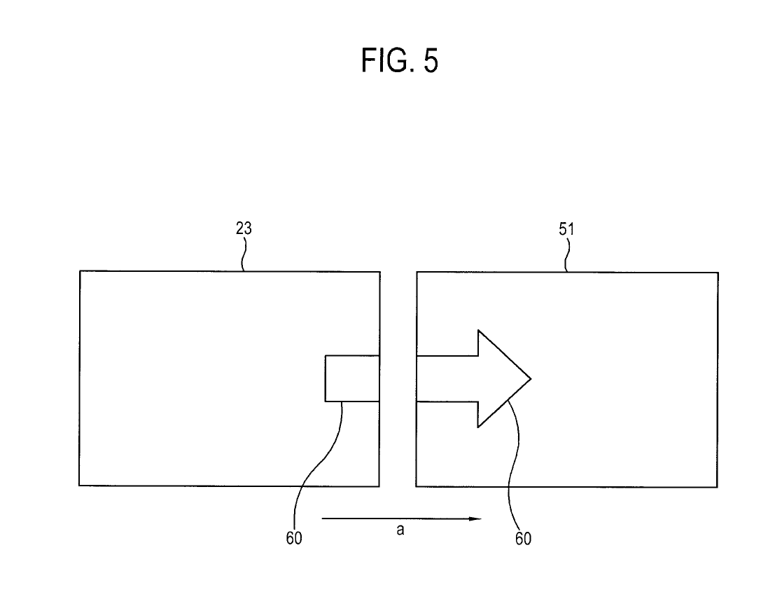

FIG. 5 is a reference view illustrating a main screen and an auxiliary screen displayed by the computer system 1 according to the exemplary embodiment of the present invention. In FIG. 5, reference numeral 23 indicates a screen displayed on the display unit 20, and reference number 51 indicates a screen displayed on the auxiliary display device 5 coupled to one of the ports 30 of the computer system 1. Meanwhile, for purposes of explanation, with regard to FIG. 4, suppose that the auxiliary display device 5 of the present exemplary embodiment is coupled to the port 30a of the ports 30.

The controller of the present exemplary embodiment identifies the port 30a as a port being coupled to the auxiliary display device 5 from among the ports 30 on the basis of the information about the positions of the ports 30 stored in advance. In this case, the port 30a is disposed to the first direction (a) on the standard position 22 corresponding to the display unit 20. The controller of the present exemplary embodiment, as shown in FIG. 5, determines to dispose the auxiliary screen 51 to the first direction (a) with respect to the main screen 23 and displays the auxiliary screen 51 on the auxiliary display device 5 according to the determined disposition.

Meanwhile, now referring to FIGS. 1 to 4, in the case of connecting the auxiliary display device 5 to the port 30, a user places the auxiliary display device 5 on a side corresponding to a position of the port 30a, i.e., on the right side of the computer system 1. This particular arrangement may be made consciously by a user, or it is highly likely that a user puts the auxiliary display device 5 on the right side of the computer system 1 even unconsciously.

Referring now back to FIG. 5, reference numeral 60 indicates an image displayed on the main screen 23 and the auxiliary screen 51. As seen from the image 60 in FIG. 5, the image 60 is not distorted but properly displayed. In this particular case, the two pieces of an arrow are shown in proper order. In the present exemplary embodiment, a distorted display of the image 60 means that the main screen 23 and the auxiliary screen 51 in FIG. 5 are switched.

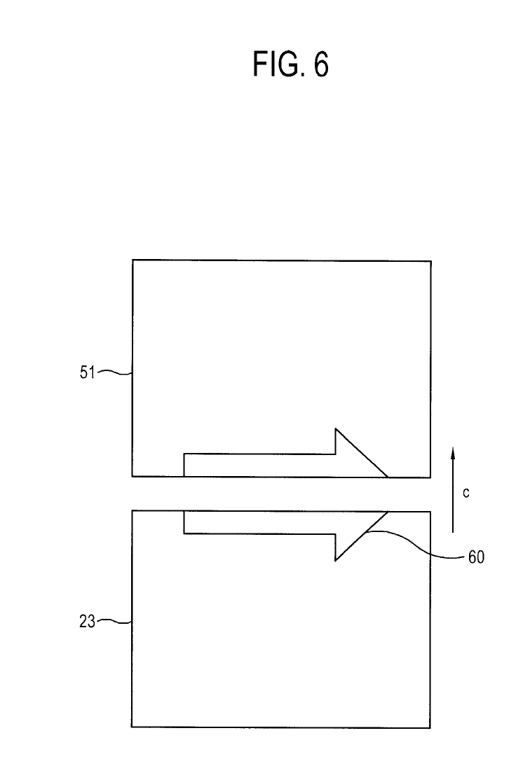

FIG. 6 illustrates a main screen and an auxiliary screen displayed by a computer system 1 according to another exemplary embodiment. In the present exemplary embodiment, suppose that an auxiliary display device 5 is coupled to a port 30c of a plurality of ports 30 shown in FIG. 4. The port 30c of the present embodiment is disposed to a third direction (C) with respect to a standard position 22 corresponding to the display 20. The controller of the present exemplary embodiment, as shown in FIG. 6, determines to dispose an auxiliary screen 51 in the third direction (C) with respect to a main screen 23 and displays the auxiliary screen 51 on the auxiliary display device 5 according to the determined disposition. In the present exemplary embodiment, it is considered that the auxiliary display device 5 is disposed behind or in an upper side of the computer system 1. In this case, the image 60 is not distorted but properly displayed, as the two halves of the arrow are aligned and in the same direction. Again, a person of ordinary skill in the art understand and appreciates that the claimed invention is not limited to an arrow image, or any geometric shape, or portions of images that fit together. For example text, colors, words, luminance, flashing characters, colors, flashing patterns, varying brightness. etc. are just a few possibilities of the many ways to show positioning via the multiple display screens.

An example of connecting the auxiliary display device to the ports 30 according to the presently claimed invention is not in any way limited to those shown in FIGS. 5 and 6, but the auxiliary display device 5 may be coupled to a port 30b. Further, not only one auxiliary display device 5 but two or more auxiliary display devices 5 may be coupled to the ports 30. In this case, the controller of the present exemplary embodiment determines positions of ports 30 coupled to the auxiliary display devices 5 and displays at least two corresponding auxiliary screens on the corresponding auxiliary display devices 5, respectively.

As described above, according to the present exemplary embodiment, a user connects the auxiliary display device 5 to any one of the ports 30 without special manipulation to immediately observe whether or not the main screen and the auxiliary screen(s) which are properly arranged, providing the user with improved convenience.

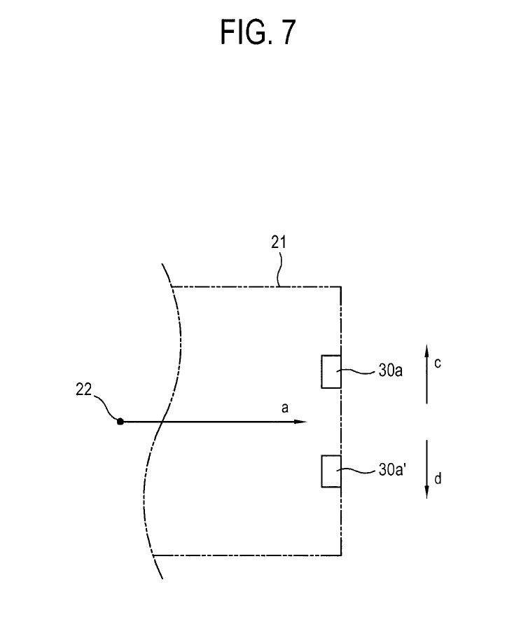

FIG. 7 illustrates position determination of a port 30 by a computer system 1 according to a second exemplary embodiment. In the present embodiment, two ports 30a and 30a′ from among a plurality of ports 30 are both disposed in the same first direction (a) with respect to a reference position 22. Further, the two ports 30a and 30a′ are positioned in a third direction (c) and in a fourth direction (d) with respect to the standard position 22 corresponding to a display unit 20, respectively. In the present exemplary embodiment, suppose that two auxiliary display devices 5 are coupled to the two ports 30a and 30a′, respectively. In this case, the two auxiliary display devices 5 are considered to be arranged in front and back, or up and down, depending on the particular circumstances of the chosen arrangement.

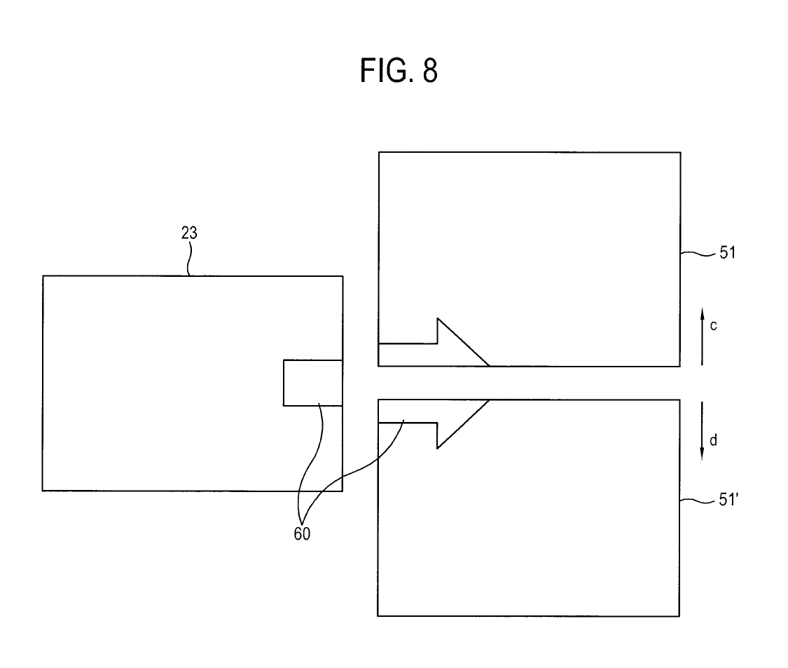

FIG. 8 is a reference view illustrating a main screen and an auxiliary screen displayed by the computer system 1 according to the present exemplary embodiment. In FIG. 8, reference numeral 23 indicates a screen displayed on the display unit 20, and reference numerals 51 and 51′ indicate screens displayed in the two auxiliary display devices 5 coupled to the two ports 30a and 30a′, respectively.

The controller of the present exemplary embodiment, as shown in FIG. 8, displays the main screen 23 on the display unit 20 and the two auxiliary screens 51 and 51′ in the two auxiliary display devices 5 coupled to the two ports 30a and 30a′ to be arranged in the first direction (a) with respect to the main screen 23. Moreover, the controller also displays the two auxiliary screens 51 and 51′ in the two corresponding auxiliary display devices 5, respectively, in consideration of relative positions of the two ports 30a and 30a′. That is, the controller determines to arrange the first auxiliary screen 51 in the third direction (c) and the second auxiliary screen 51′ in the fourth direction (d).Thus, the auxiliary screens 51 and 51′ prime are to the right of the main screen 23 and are vertically arranged in proper order in accordance with third direction (c) and fourth direction (d).

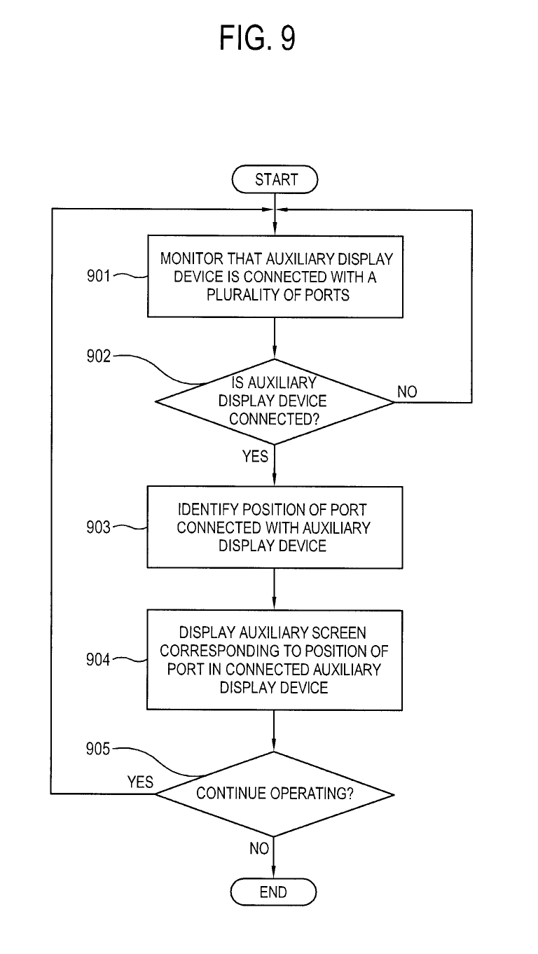

Meanwhile, the controller of the present exemplary embodiment may perform the display setting of the main screen and the auxiliary screen when the auxiliary display devices 5 are coupled to the ports 30. FIG. 9 is a flow chart illustrating an exemplary operation of a computer system 1 according to an exemplary embodiment of the present invention.

At step (901), a controller of the present embodiment monitors whether at least one of a plurality of ports 30 is coupled to an auxiliary display device 5.

Then, at step (902), at least one of the ports 30 is coupled to the auxiliary display device 5, and at step (903) the controller identifies a position of a port coupled to the auxiliary display device 5.

At step (904), the controller displays a main screen on a display unit 20 and an auxiliary screen corresponding to the position of the port 30 in a corresponding auxiliary display device 5. Meanwhile, the controller of the present exemplary embodiment identifies whether to continue the operation. If continuing, at step (905) the controller repeats the stages 901 to 904, or otherwise, the controller completes the operation.

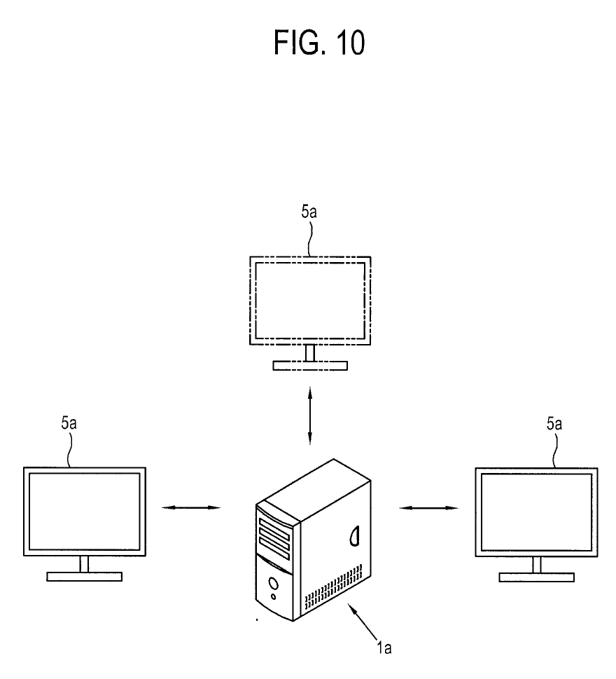

Hereinafter, a computer system according to another exemplary embodiment of the present invention will be illustrated. FIG. 10 illustrates a computer system 1a according to another exemplary embodiment. In the following description, the same or similar components of computer system 1a when compared to those of computer system 1 in FIGS. 1 to 9 are not discussed to avoid repetition.

The computer system 1a shown in FIG. 10 may be realized as a PC such as a desktop. The computer system 1a of the present exemplary embodiment includes a plurality of ports (not shown), and the ports are coupled(typically respectively) with a plurality of display devices 5a. The ports of the computer system 1a may be disposed in various positions of a housing (or a case) of the computer system 1a.

The computer system 1a of the present exemplary embodiment displays a main screen in any of the display devices 5a and displays an auxiliary screen in at least another device thereof on the basis of relative positions of the ports coupled to the display devices 5a. For example, a device in position (c) may display the auxiliary screen while in positions (a) and (b) may display the main screen.

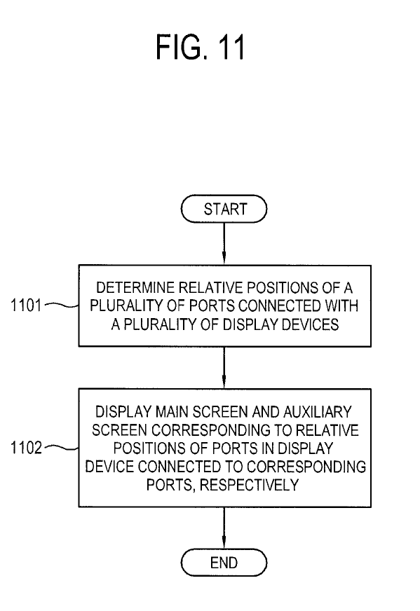

FIG. 11 is a flow chart illustrating an operation of the computer system 1a according to the present exemplary embodiment. At step (1101), the computer system 1a of the present exemplary embodiment determines relative positions of the ports coupled to the display devices 5a. The determination of the relative positions of the ports performed by the computer system 1a of the present embodiment at 1101 may be deduced from the configuration of the aforementioned computer system 1, and such explanation is not repeated herein.

At step (1102), the computer system 1a of the present exemplary embodiment displays a main screen and at least one auxiliary screen in display devices 5a coupled to corresponding ports on the basis of the relative positions of the ports coupled to the display devices 5a. Likewise, the display of the main screen and the auxiliary screen performed by the computer system 1a of the present embodiment according to the relative positions of the ports may be deduced from the configuration of the aforementioned computer system 1, which is not repeatedly explained.

The above-described methods according to the present invention can be realized in hardware or as software or computer code that can be stored in a machine readable recording medium such as a CD ROM, DVD, a RAM, thumbnail drive, a floppy disk, a flash storage, a hard disk, or a magneto-optical disk or downloaded over a network and stored as a non-transitory data on one of the aforementioned mediums, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

As described above, the present invention provides a user with improved convenience in displaying a screen on a mounted display unit and an auxiliary display device or in a plurality of display devices.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A computer system comprising:
a display unit;
a plurality of ports connectable with at least one auxiliary display device; and
a controller for controlling display of a main screen on the display unit and an auxiliary screen on the at least one auxiliary display device corresponding to a position of a particular port coupled to a particular auxiliary display device from among the ports.

2. The computer system according to claim 1, wherein each of the ports are arranged in a direction with respect to a standard position corresponding to an orientation of the display unit, and the controller controls display of an auxiliary screen corresponding to the arrangement direction of the particular port with respect to the standard position in the auxiliary display device coupled to the particular port.

3. The computer system according to claim 2, wherein two or more of the ports are arranged in the same direction with respect to the standard position, and the controller displays two or more auxiliary screens of two or more respective auxiliary devices corresponding to relative positions of the two or more ports respectively coupled to the two or more auxiliary display devices.

4. The computer system according to claim 1, further comprising a housing in which the controller is provided, wherein each of the ports is provided on any one surface of the housing.

5. The computer system according to claim 2, further comprising a housing in which the controller is provided, wherein each of the ports is provided on any one surface of the housing.

6. The computer system according to claim 3, further comprising a housing in which the controller is provided, wherein each of the ports is provided respectively on any one surface of the housing.

7. The computer system according to claim 1, wherein the controller performs display setting of the main screen of the display unit and the auxiliary screen of the respective auxiliary devices if the ports are coupled to the auxiliary display devices.

8. The computer system according to claim 2, wherein the controller performs display setting of the main screen of the display unit and the auxiliary screen of the respective auxiliary devices if the ports are coupled to the auxiliary display devices.

9. The computer system according to claim 3, wherein the controller performs display setting of the main screen of the display unit and the auxiliary screen of the respective auxiliary devices if the ports are coupled to the auxiliary display devices.

10. The computer system according to claim 7, wherein the controller changes display settings of the main screen of the display unit and the auxiliary screen of the respective auxiliary devices according to received input.

11. The computer system according to claim 7, wherein the display settings of the main screen and the auxiliary comprise at least portions of an image or a sequence of images that are aligned when the display unit and the auxiliary devices are properly positioned.

12. The computer system according to claim 11, wherein the image comprises at least one of a geometric shape, text, colors, words, flashing patterns, varying brightness.

13. A method of controlling a computer system comprising:
determining a position of a port coupled to at least one auxiliary display device among a plurality of ports of the computer system; and
displaying a main screen on a display unit of the computer system and an auxiliary screen corresponding to the position of a particular port in the auxiliary display device.

14. The method according to claim 13, wherein each of the ports are arranged in a direction with respect to a standard position corresponding to the display unit, and the displaying the auxiliary screen comprises displaying an auxiliary screen corresponding to the arrangement direction of the particular port with respect to the standard position in the auxiliary display device coupled to the particular port.

15. The method according to claim 14, wherein two or more of the ports are arranged in the same direction with respect to the standard position, and the displaying of the auxiliary screen comprises displaying two or more auxiliary screens corresponding to relative positions of the two or more ports in the two or more auxiliary display devices coupled to the two or more ports.

16. The method according to claim 13, further comprising performing display setting of the main screen and the auxiliary screen if the ports are coupled to the auxiliary display devices.

17. The method according to claim 14, further comprising changing display settings of the main screen and the auxiliary screen according to a received input.

18. The method according to claim to 16, wherein the display settings of the main screen and the auxiliary comprise at least portions of an image or a sequence of images that are aligned when the display unit and the auxiliary devices are properly positioned.

19. The method according to claim 18, wherein the image comprises at least one of a geometric shape, text, colors, words, flashing patterns, varying brightness.

20. A computer system comprising:
a plurality of ports adapted for coupling with a plurality of display devices; and
a controller displaying a main screen corresponding to relative positions of the ports coupled to the display devices and at least one auxiliary screen in the display devices coupled to the ports, respectively.

21. A method of controlling a computer system comprising:
determining relative positions of a plurality of ports of the computer system coupled to a plurality of display devices; and
displaying a main screen corresponding to the relative positions of the ports and at least one auxiliary screen in the display devices coupled to the ports, respectively.
